(19) United States
(12) Patent Application Publication
(10) Pub. No.: US 2010/0195570 A1
(43) Pub. Date: Aug. 5, 2010

(54) COMMUNICATION CONTROL SYSTEM, COMMUNICATION CONTROL METHOD AND COMMUNICATION CONTROLLER

(75) Inventors: Toshiyuki Tamura, Tokyo (JP); Andreas Kunz, Heidelberg (DE)

Correspondence Address: YOUNG & THOMPSON, 209 Madison Street, Suite 500, Alexandria, VA, 22314, US

(73) Assignee: NEC CORPORATION, Tokyo (JP)

(21) Appl. No.: 12/669,273

(22) PCT Filed: Jul. 10, 2008
(86) PCT No.: PCT/JP2008/062870

§ 371 Date: Jan. 15, 2010

(30) Foreign Application Priority Data
Jul. 27, 2007 (JP) 2007-196734

(51) Int. Cl. H04W 40/04; H04L 29/06

(52) U.S. Cl. 370/328; 370/352

(57) ABSTRACT

A communication control system connects a call using a local service number valid within a local service area within which a user equipment is positioned, and forwards data via an internet protocol network, including a local number converter and a session controller group. The local number converter is located in each local service area, in response to a query specifying a local service number, accesses a database of correspondence between a local service number valid within the local service area and a global routable number, and determines a global routable number corresponding to the specified local service number. The session controller group accepts a call request including the local service number from the user equipment, queries the local number converter in the local service area to convert the local service number into a global routable number, and routes the internet protocol network using the global routable number.

### TECHNICAL FIELD

The present invention relates to a mobile communication system.

### BACKGROUND ART

### Introduction

The IP Multimedia Subsystem (IMS) is gradually penetrating over the CS (Circuit Switched) domain telephony network in order to provide rich and flexible services to end users. For end users perspective, existing telephony services should be continuously supported over the IMS and network evolution toward the IMS should be even invisible to end users.

This paper farceuses on how local services, including local number dialing, Emergency call, and other localized services can be continuously provided over the IMS and considers smooth migration from CS domain to IMS.

### <<System Analysis>>

### <Local Service Number Control in CS Domain>

FIG. 1 presents the legacy implementation of local service numbers in the CS domain.

In case UE (User Equipment) dials the Local Service Number, the MSC (Mobile Switching Center) detects that the dialed number is not in a format according to the international ISDN numbers (E.164) and queries a local database to resolve the dialed number into a routable number. The database is typically collocated with the MSC. A routable number should not necessarily be a global routable number since the call control is performed in the visited MSC locally. Examples of local service numbers are emergency calls: if a subscriber dials 112, the resolution of 112 into a “real” telephone number like 123 4567 would be different based on the geographic location of the subscriber. The reason for this is that the subscriber shall get help from the closest emergency centre and not from one far away.

The benefits include no need for a centralized database for all local services in all regions in the network and a situation in which it is easier to maintain smaller databases that are collocated with the serving nodes in the network.

### <Local Service Number Control in IMS>

3GPP 23.228 describes the routing of calls when a user is using a number in a non-international format according to an addressing plan used in the visited network or a geo-local service number. The UE shall include an indication in the Request URI of the SIP (Session Initiation Protocol) request that it intends to use local services as well as to use a local addressing plan. This indication shall be included in the Request URI of the SIP request. Since IMS service is basically provided in home network, it is assumed that support of local number will also be provided in home network with the centralized manor.

FIG. 2 shows the normal call setup scenario within one operator network without local service numbers. An originating call from the UE is send from the P (Proxy)-CSCF (Call Session Control Function) to the I (Interrogating)-CSCF, which queries the HSS (Home Subscriber Server) for the right S (Serving)-CSCF. Then the I-CSCF forwards the call to the S-CSCF and the S-CSCF uses normal IMS routing to terminate the call. In case the dialed number is a local number, the S-CSCF invokes an Application Server (AS), shown as Location Retrieval Function (LRF) in FIG. 2, to convert a dialed number into global routable format. Then the S-CSCF routes the SIP request, via normal IMS routing principles, towards its destination.

Further, the FIG. 3 shows an operator network with different local service areas.

Within each service area there might be a dedicated P-CSCF to serve the subscribers in this area.

The P-CSCF shall route the session towards the S-CSCF as per the session origination procedures. The S-CSCF evaluates the Request URI and queries an Application Server (AS) for the translation of the local number into a globally routable format with the subscriber's location (Local Area in the FIG. 3) taking into account. The AS then returns the translated Request URI that contains either a globally routable SIP URI or a Tel URI with the number in an international format back to the S-CSCF. The S-CSCF routes the SIP request, via normal IMS routing principles, towards its destination.

### <IMS Emergency Calls>

3GPP TS 23.167 defines the emergency session control in the IMS. FIG. 4 shows an emergency IMS registration scenario. It is assumed here that the Emergency-CSCF (E-CSCF) is collocated with the normal S-CSCF as the typical implementation option.

The E-CSCF has the interface with the Location Retrieval Function (LRF) as the additional function on the S-CSCF. The LRF is responsible for retrieving the location information of the UE that has initiated an IMS emergency session. It is possible to support configurations where the Location Retrieval Function (LRF) may consist of a Routing Determination Function (RDF) and a Location Server (e.g. GMLC (Gateway Mobile Location Center)).

### <IMS Localized Services>

IMS Localized Services other than Emergency Calls can be realized in a similar way as in the traditional CS domain, see FIG. 5. If the IMS UE dials a Local Service URI (LSURI) with an indication that it is using local services as well as a local addressing plan, the request is forwarded to the P-CSCF. The P-CSCF forwards the request with the LSURI to the I-CSCF which determines with a HSS/HLR (Home Location Resister) query the appropriate S-CSCF. The I-CSCF then forwards the request to the S-CSCF. The S-CSCF detects that a local URI is called and invokes an Application Server, shown as the Location Retrieval Function (LRF) in FIG. 5 to resolve this. The response of the query from the AS contains a Globally Routable URI (GRURI). Based on the GRURI the S-CSCF can now invoke the local services.

### DISCLOSURE OF THE INVENTION

### Smooth Migration from CS Domain Based Local Services to IMS Based Local Service

Based on the analysis in the section of <<System Analysis>>, it is concluded that while the CS domain maintains the local service database and number translator in the visited network locally, the IMS maintains the global database in the home network in a centralized manor.

It is anticipated by the operator that smooth migration from CS domain to IMS is beneficial. The section of <<Solution>> describes the solutions in IMS how local services can be provided similar manor with CS domain.

IMS localized services can be done in several ways. Key idea is the same behavior as in the CS domain, i.e. distributed databases that a queried by an application server. The Location Retrieval Function (LRF) has the best knowledge of the location of a user. In addition to the location parameters within the request URI, the LRF could do additional location queries to acquire a more accurate position of the subscriber. The LRF can therefore also act as an AS to resolve location dependent number queries into an international, globally routable format. There can be several architectures to solve this issue.

### <<Concept of Solution>>

A communication control system according to an exemplary aspect of this invention is a communication control system for connecting a call using a local service number valid within a local service area within which a user equipment is positioned, and for forwarding data via an internet protocol network, comprising:

a local number converter that is located in each local service area that, in response to a query specifying a local service number, accesses a database of correspondence between a local service number valid within the local service area and a global routable number, and determines a global routable number corresponding to the specified local service number; and

a session controller group that accepts a call request including the local service number from the user equipment, queries the local number converter in the local service area within which the user equipment is positioned to convert the local service number into a global routable number, and routes the internet protocol network using the global routable number.

A communication control method according to an exemplary aspect of this invention is a communication control method in a communication system for connecting a call using a local service number valid within a local service area within which a user equipment is positioned, and for forwarding data via an internet protocol network, comprising:

accepting a call request including a local service number from the user equipment;

among local number converters that are located in each local service area that, in response to a query specifying a local service number, access a database of correspondence between a local service number valid within the local service area and a global routable number, and determine a global routable number corresponding to the specified local service number, querying a local number converter in a local service area within which the user equipment is positioned to convert the local service number into a global routable number; and

routing the internet protocol network using the global routable number.

A communication controller according to an exemplary aspect of this invention is a communication controller used with a local number converter that is located in each local service area that, in response to a query specifying a local service number, accesses a database of correspondence between a local service number valid within the local service area and a global routable number, and determines a global routable number corresponding to the specified local service number:

in a communication control system for connecting a call using the local service number valid within the local service area within which a user equipment is positioned, and for forwarding data via an internet protocol network, wherein

a query is put to a local number converter in the local service area within which the user equipment that issued a call request, including the local service number, is positioned to convert the local service number into the global routable number.

The above and other objects, features, and advantages of the present invention will become apparent from the following description with references to the accompanying drawings which illustrate exemplary embodiments or examples of the present invention.

### BRIEF DESCRIPTION OF THE DRAWINGS

FIG. 1 shows Local Service Numbers in the CS domain;

FIG. 2 shows Typical Operator IMS Topology;

FIG. 3 shows Operator Network with different Local Service Areas;

FIG. 4 shows IMS Emergency Call Scenario;

FIG. 5 shows IMS Concept of Local Service Translation;

FIG. 6 shows LRF AS in each Local Service Area;

FIG. 7 shows Reuse of CS local Service Database;

FIG. 8 shows LRF in each Local Service Area selected by LAAS;

FIG. 9 shows Collocated P-CSCF with LRF in each Local Service Area.

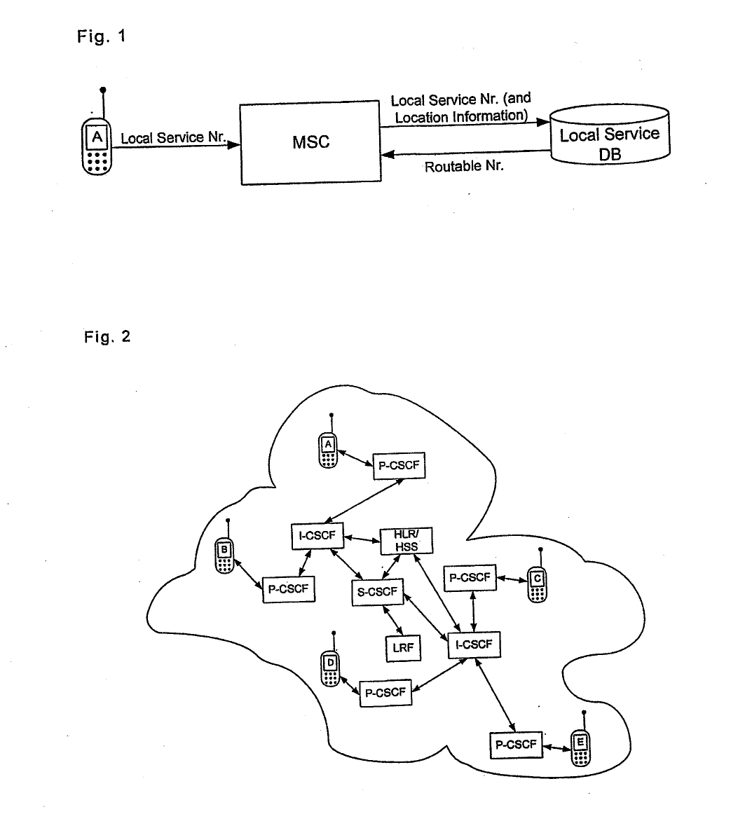

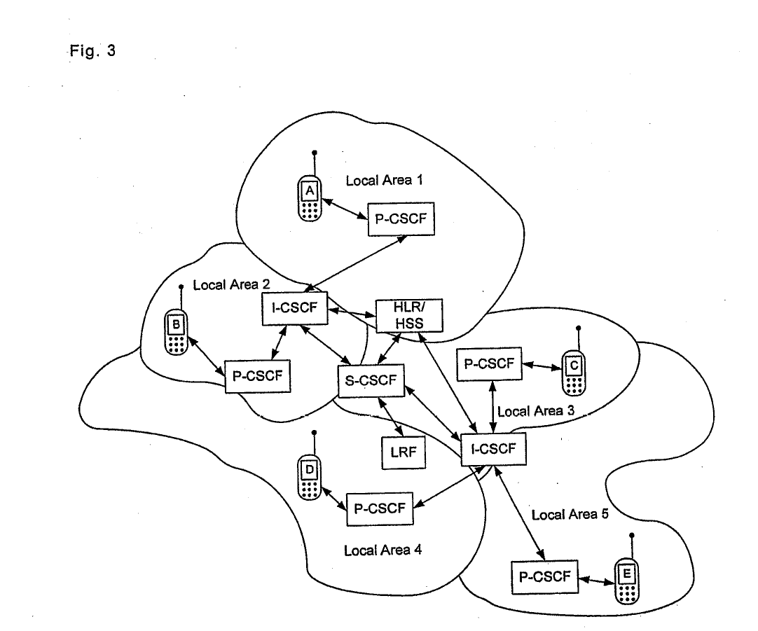

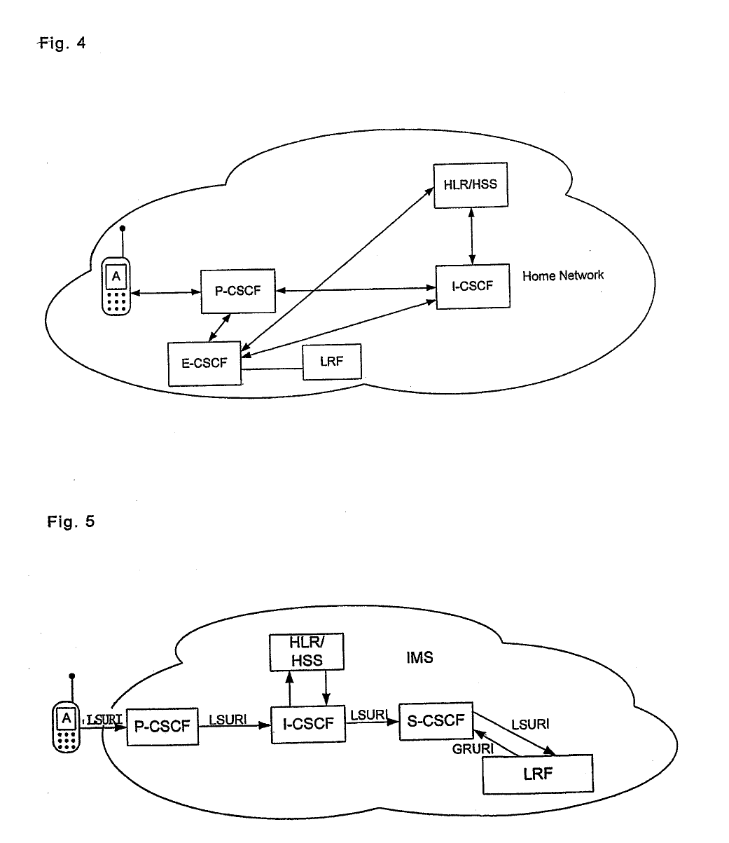

### BEST MODE FOR CARRYING OUT THE INVENTION

### <<Solution: LRF as an Application Server for Local Number Translation >>

<Solution 1: LRF AS in each Local Service Area>

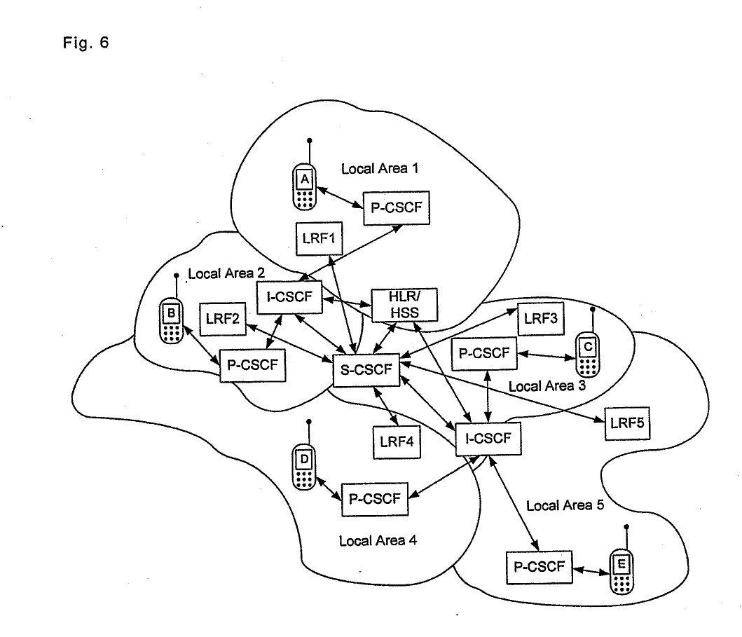

The main idea is described in FIG. 6 as an individual LRF per Local Service Area. Each of these individual LRFs may have different sets of local numbers, or the same set with different resolutions. For example if someone has a breakdown with his car on the highway, the local automobile roadway repair service shall be called and not one which is far away.

In FIG. 6, an incoming request at one of the local P-CSCFs is routed to the I-CSCF which selects after a HLR/HSS query the S-CSCF. The UE might additionally add some location information in this request like the cell id, GPS (Global Positioning System) coordinates or OMA (Open Mobile Alliance) SUPL (Secure User Plane Location) information. The S-CSCF can detect the local number indication in the request and also can detect to which LRF the local number query shall be sent. The LRF selection can be based on location information provided by the UE. The local LRF may access the local CS local number database or may maintain an own database to resolve the request. Here the LRF acts as an AS. When the LRF returns the globally routable URI, the S-CSCF can invoke the service.

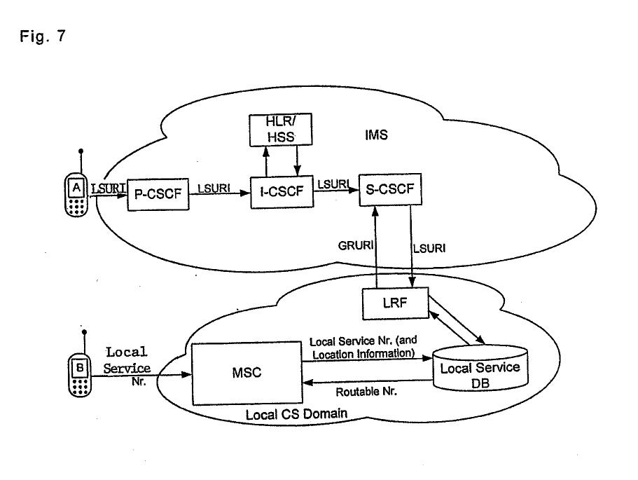

FIG. 7 illustrates the case where Local LRF obtains the globally routable URI with the help of Local CS local number database. Sharing the local number database between CS domain and IMS provides a significant advantage to the operator because of easy maintenance.

### <Solution 2: LRF in Each Local Service Area Selected by LAAS>

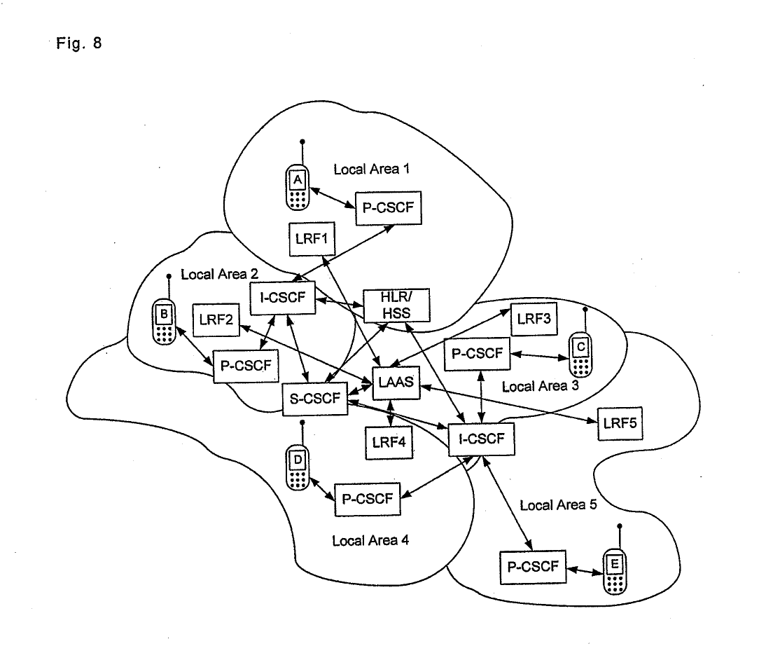

One other possibility for selecting the LRF in each location area could be done by one centralized node, the so called Local Area Application Server (LAAS). The architecture is shown in FIG. 8. In principle the sequence of the messages is the same as in the chapter of <Solution 1>, but here the S-CSCF does not need to do any LRF selection. The S-CSCF just makes a local number resolution query to the LAAS. The LAAS now has enough knowledge to choose the appropriate LRF in the correct region and forwards the query there. The local LRF resolves the query and returns the globally routable URI to the LAAS which further forwards the result to the S-CSCF. The S-CSCF can now invoke the correct local service.

### <Solution 3: Co-Located P-CSCF and LRF AS in Each Local Service Area>

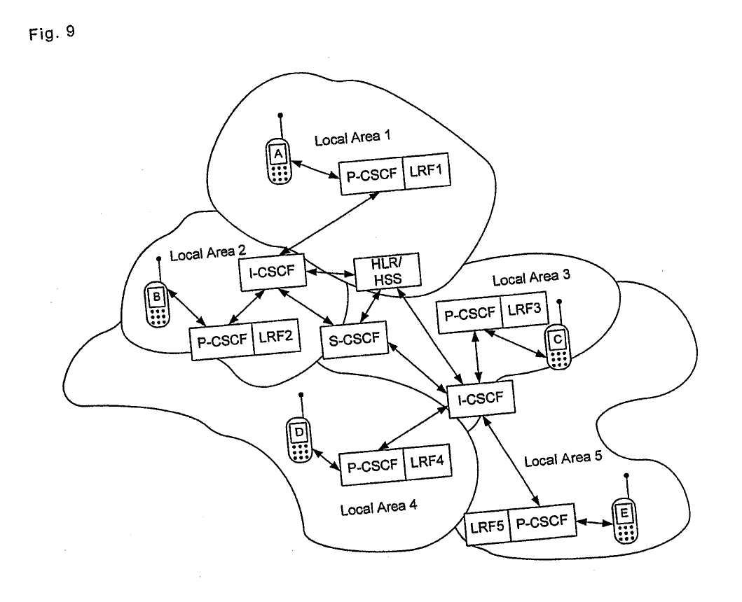

One other way can be direct translation of the local URI into a global URI at the P-CSCF. Therefore the LRF could be co-located with the P-CSCF, as shown in FIG. 9. If an incoming local service request is coming to the P-CSCF, it could detect it based on the indication set by the UE. The P-CSCF then can then exchange with the help of the LRF the local request header with the appropriate global routable request header and then forward the request to the I-CSCF. Then only normal IMS routing is done to complete the session and invoke the local service.

### <<Proposed Concepts>>

Proposed concepts are included in methods of providing a local number translation based on the geographic location of the subscriber. The method is done with
1. A IMS system composed of the following functions that provides local number services with a distributed number translation database as similar manor with CS domain telephony service; (All functions below are already defined in the 3GPP standard)
   a. A UE sends a Local URI request to the P-CSCF with an indication that local service is being invoked.
   b. The S-CSCF can interwork with any Application Servers even if it is located outside of home network.
   c. The S-CSCF detects the local service invocation and forwards it to the appropriate Application server.
   d. Application server has the ability to translate the local number to the globally routable URI by referring to the location information.
2. The S-CSCF has the ability to select a local LRF that is located in the local area where subscriber is located. (Solution 1)
3. The S-CSCF selects a local LRF based on location information such as cell identifier, GPS information, SUPL information standardized by OMA etc or based on the P-CSCF address or initial filter criteria for certain local areas. (Solution 1)
4. The local LRF is able to translate the local number, that is only effective where a subscriber is located, into a globally routable URI. (Solution 1)
5. The local LRF as the Application server for IMS is collocated or interworks with the local service database of CS domain service. (Solution 1)
6. The S-CSCF may send a local number resolve query to the local LRF directly or to an AS like a LAAS, which selects the local LRF and which forwards the query there (Solution 1 and Solution 2)
7. A P-CSCF detects the Local Request URI and either forwards it as is or directly translates the Local Request URI to a globally routable URI format and forwards it to the I-CSCF. (Solution 3)
8. The LRF may be collocated with the P-CSCF. (Solution 3)

While exemplary embodiments of the present invention have been described using specific terms, such description is for illustrative purposes only, and it is to be understood that changes and variations may be made without departing from the spirit or scope of the following claims.

The above mentioned exemplary embodiments may be organized into the following examples.

Example 1 is a communication control system for connecting a call using a local service number valid within a local service area within which user equipment is positioned, and for forwarding data via an internet protocol network, comprising:

a local number converter (corresponding to an LRF) that is located in each local service area that, in response to a query specifying a local service number, accesses a database of correspondence between a local service number valid within the local service area and a global routable number (corresponding to a local service DB), and determines a global routable number corresponding to the specified local service number; and

a session controller group (corresponding to CSCFs) that accepts a call request including the local service number from the user equipment, queries the local number converter in the local service area within which the user equipment is positioned to convert the local service number into a global routable number, and routes the internet protocol network by using the global routable number.

Example 2 is the communication control system according to example 1, wherein

the session controller group comprises a proxy session controller (corresponding to a P-CSCF) located in a visited network, and a serving session controller (corresponding to an S-CSCF),

the proxy session controller accepts the call request from the user equipment, and forwards the call request to the serving session controller, and

the serving session controller, upon receiving the call request, queries the local number converter about a global routable number corresponding to the local service number, and routes the internet protocol network using the global routable number.

Example 3 is the communication control system according to example 2, wherein the serving session controller selects the local number converter of the query destination based on location information for the user equipment.

Example 4 is the communication control system according to example 2, wherein the serving session controller selects the local number converter of the query destination based on address information for the proxy session controller that forwarded the call request.

Example 5 is the communication control system according to example 2, wherein the serving session controller selects the local number converter of the query destination based on a predetermined criterion.

Example 6 is the communication control system according to example 2, further comprising:

a local area application server (corresponding to an LAAS) for, among a plurality of local number converters for each local service area, receiving a query about a global routable number corresponding to the local service number, selecting a local number converter suitable for a query destination of the query and forwarding the query to the local number converter,

wherein the serving session controller queries the local number converter about a global routable number corresponding to the local service number via the local area application server.

Example 7 is the communication control system according to example 1, wherein

the session controller group comprises a proxy session controller located in the visited network, and a serving session controller,

the proxy session controller accepts a call request from the user equipment, queries the local number converter about a global routable number corresponding to the local service number, and forwards the call request in which the local service number has been converted into the global routable number to the serving session controller, and

the serving session controller, upon receiving the call request, routes the internet protocol network by using the global routable number.

Example 8 is the communication system according to example 7, wherein the local number converter is collocated with the proxy session controller.

Example 9 is the communication control system according to example 2 or 7, further comprising in a home network a query session controller (corresponding to an I-CSCF) that receives a request from the proxy session controller, queries a subscriber information server to select a serving session Controller that should take charge of the request, and forwards the request to the selected serving session controller.

Example 10 is the communication control system according to any one of examples 1 to 9, wherein the local number converter shares with a circuit switched network, a database of correspondence between a local service number valid within the local service area and a global routable number.

Example 11 is a communication control method in a communication system for connecting a call using a local service number valid within a local service area within which a user equipment is positioned, and for forwarding data via an internet protocol network, comprising:

accepting a call request including a local service number from the user equipment;

among local number converters that are located in each local service area that, in response to a query specifying a local service number, accessing a database of correspondence between a local service number valid within the local service area and a global routable number, and determining a global routable number corresponding to the specified local service number, querying a local number converter in a local service area within which the user equipment is positioned to convert the local service number into a global routable number; and

routing the internet protocol network by using the global routable number.

Example 12 is the communication control method according to example 11, wherein

the proxy session controller located in the visited network accepts the call request from the user equipment, and forwards the call request to the serving session controller, and

the serving session controller, upon receiving the call request, queries the local number converter about a global routable number corresponding to the local service number, and routes the internet protocol network using the global routable number.

Example 13 is the communication control method according to example 11, wherein

the proxy session controller located in the visited network accepts a call request from the user equipment, queries the local number converter about a global routable number corresponding to the local service number, and forwards the call request in which the local service number has been converted into the global routable number to the serving session controller, and

the serving session controller, upon receiving the call request, routes the internet protocol network using the global routable number.

Example 14 is a communication controller used with a local number converter that is located in each local service area, in response to a query specifying a local service number, accesses a database of correspondence between a local service number valid within the local service area and a global routable number, and determines a global routable number corresponding to the specified local service number:

in a communication control system for connecting a call using the local service number valid within the local service area within which user equipment is positioned, and for forwarding data via an internet protocol network, wherein

a query is put to a local number converter in the local service area, within which the user equipment that issued a call request, including the local service number, is positioned to convert the local service number into the global routable number.

This application is based upon and claims the benefit of priority from Japanese Patent Application No. 2007-196734 filed in Japan Patent Office on Jul. 27, 2007, the contents of which are hereby incorporated by reference.

1. A communication control system that connects a call using a local service number valid within a local service area within which user equipment is positioned, and forwards data via an internet protocol network, comprising:
a local number converter that is located in each local service area that, in response to a query specifying a local service number, accesses a database of correspondence between a local service number valid within the local service area and a global routable number, and determines a global routable number corresponding to the specified local service number; and
a session controller group that accepts a call request including the local service number from the user equipment, queries the local number converter in the local service area within which the user equipment is positioned to convert the local service number into a global routable number, and routes the internet protocol network using the global routable number.

2. The communication control system according to claim 1, wherein
the session controller group comprises a proxy session controller located in a visited network, and a serving session controller,
the proxy session controller accepts the call request from the user equipment, and forwards the call request to the serving session controller, and
the serving session controller, upon receiving the call request, queries the local number converter about a global routable number corresponding to the local service number, and routes the internet protocol network by using the global routable number.

3. The communication control system according to claim 2, wherein the serving session controller selects the local number converter of the query destination based on location information for the user equipment.

4. The communication control system according to claim 2, wherein the serving session controller selects the local number converter of the query destination based on address information for the proxy session controller that forwarded the call request.

5. The communication control system according to claim 2, wherein the serving session controller selects the local number converter of the query destination based on a predetermined criterion.

6. The communication control system according to claim 2, further comprising:
a local area application server that, among a plurality of local number converters for each local service area, receives a query about a global routable number corresponding to the local service number, selects a local number converter suitable for a query destination of the query and forwards the query to the local number converter,
wherein the serving session controller queries the local number converter about a global routable number corresponding to the local service number via the local area application server.

7. The communication control system according to claim 1, wherein
the session controller group comprises a proxy session controller located in the visited network, and a serving session controller,
the proxy session controller accepts a call request from the user equipment, queries the local number converter about a global routable number corresponding to the local service number, and forwards the call request in which the local service number has been converted into the global routable number to the serving session controller, and
the serving session controller, upon receiving the call request, routes the internet protocol network by using the global routable number.

8. The communication system according to claim 7, wherein the local number converter is collocated with the proxy session controller.

9. The communication control system according to claim 2, further comprising in a home network a query session controller that receives a request from the proxy session controller, queries a subscriber information server to select a serving session controller that should take charge of the request, and forwards the request to the selected serving session controller.

10. The communication control system according to claim 1, wherein the local number converter shares with a circuit switched network, a database of correspondence between a local service number valid within the local service area and a global routable number.

11. A communication control method in a communication system that connects a call using a local service number valid within a local service area within which a user equipment is positioned, and forwards data via an internet protocol network, comprising:
accepting a call request including a local service number from the user equipment;
among local number converters that are located in each local service area, in response to a query specifying a local service number, accessing a database of correspondence between a local service number valid within the local service area and a global routable number, and determining a global routable number corresponding to the specified local service number, querying a local number converter in a local service area within which the user equipment is positioned to convert the local service number into a global routable number; and
routing the internet protocol network by using the global routable number.

12. The communication control method according to claim 11, wherein
the proxy session controller located in the visited network accepts the call request from the user equipment, and forwards the call request to the serving session controller, and
the serving session controller, upon receiving the call request, queries the local number converter about a global routable number corresponding to the local service number, and routes the internet protocol network using the global routable number.

13. The communication control method according to claim 11, wherein
the proxy session controller located in the visited network accepts a call request from the user equipment, queries the local number converter about a global routable number corresponding to the local service number, and forwards the call request in which the local service number has been converted into the global routable number to the serving session controller, and
the serving session controller, upon receiving the call request, routes the internet protocol network by using the global routable number.

14. A communication controller used with a local number converter that is located in each local service area, in response to a query specifying a local service number, accesses a database of correspondence between a local service number valid within the local service area and a global routable number, and determines a global routable number corresponding to the specified local service number:
in a communication control system that connects a call using the local service number valid within the local service area within which a user equipment is positioned, and forwards data via an internet protocol network, wherein
a query is put to a local number converter in the local service area within which the user equipment issued a call request including the local service number is positioned to convert the local service number into the global routable number.

15. The communication control system according to claim 7, further comprising in a home network a query session controller that receives a request from the proxy session controller, queries a subscriber information server to select a serving session controller that should take charge of the request, and forwards the request to the selected serving session controller.

16. The communication control system according to claim 2, wherein the local number converter shares with a circuit switched network, a database of correspondence between a local service number valid within the local service area and a global routable number.

17. The communication control system according to claim 3, wherein the local number converter shares with a circuit switched network, a database of correspondence between a local service number valid within the local service area and a global routable number.

18. The communication control system according to claim 4, wherein the local number converter shares with a circuit switched network, a database of correspondence between a local service number valid within the local service area and a global routable number.

19. The communication control system according to claim 5, wherein the local number converter shares with a circuit switched network, a database of correspondence between a local service number valid within the local service area and a global routable number.

20. The communication control system according to claim 6, wherein the local number converter shares with a circuit switched network, a database of correspondence between a local service number valid within the local service area and a global routable number.
